(19) United States
(12) Patent Application Publication
(10) Pub. No.: US 2011/0177241 A1
(43) Pub. Date: Jul. 21, 2011

(54) COATING FORMULATION AFFORDING ANTIREFLECTION EFFECTS ON TRANSPARENT SUBSTRATE AND METHOD FOR MANUFACTURING TRANSPARENT SUBSTRATE WITH ANTIREFLECTION FUNCTION USING SAID COATING FORMULATION

(75) Inventors: Kyu Wang Lee, Gyeonggi-do (KR); Young Min Kim, Gyeonggi-do (KR)

(73) Assignee: ECOPERA INC., Hwascong-si, Gyeonggi-do (KR)

(21) Appl. No.: 13/056,597

(22) PCT Filed: Jul. 27, 2009
(86) PCT No.: PCT/KR2009/004150

§ 371 Date: Jan. 28, 2011

(30) Foreign Application Priority Data
Aug. 11, 2008 (KR) 10-2008-0078441
Jul. 17, 2009 (KR) 10-2009-0065282

(51) Int. Cl. B05D 5/06; C09D 1/00; B05D 3/00; B05D 3/10; B82Y 30/00

(52) U.S. Cl. 427/165; 106/286.8; 106/287.26; 427/164; 977/773

(57) ABSTRACT

The present invention provides a method for preparing a glass substrate with antireflection functionality by applying a coating formulation that affords antireflection effects to a substrate comprising water, metalloid oxide nano particles that are dispersed in said water, and a hydroxide ion agent or fluoride ion agent that is introduced into said metalloid oxide nano particles at a mole ratio of 0.005˜2:1. The coating formulation of the present invention enables manufacture of a porous nano antireflection film with high transmittance following a more streamlined process than the prior art, obtaining an antireflection film with a high adhesive force between the film and substrate, and high durability by increasing particle-particle bonding and the bond strength between particles and substrate.

### TECHNICAL FIELD

The present invention relates to a coating formulation affording antireflection effects on a transparent substrate and a method for manufacturing a transparent substrate with an antireflection function using the coating formulation.

### BACKGROUND ART

When a person watches a television screen under an environment with bright light, the person cannot recognize clearly the contents displayed on the screen due to reflections which occur since glass or optical resin used to manufacture glasses and display has a lot of reflectivity, not providing 100% light transmittance. An antireflection (AR) technology becomes widespread for decreasing reflectivity and enhancing light transmittance with the aid of surface process of a transparent substrate in order to maintain a constant image resolution of an optical transparent substrate. The AR technology can be widely applied to an optical instrument such as a telescope, glasses, optical communication parts, a photoelectric element, a solar device and a display part.

The antireflection technology by means of a surface process of a transparent substrate can be classified into a technology of etching a surface to a fine pattern and an AR coating technology of porous coating a surface.

The fine pattern etching method is directed to forming a fine protrusion pattern on a substrate surface by performing a non-uniform etching with respect to a substrate.

The AR coating technology has advanced to a four-layer AR coating technology since Geffken disclosed a 3-layer AR coating invention in 1940. The U.S. Pat. No. 5,856,018 discloses a four-layer coating technology of SiO₂/TiO₂/SiO₂/TiO₂ which is adapted onto a substrate of polymethylmethacrylate. The Korean patent number 10-1994-0036298 is discloses a refection decrease coating in which a high reflection layer, a low reflection layer and a protrusion low reflection layer are sequentially coated. The conventional reflection decrease coating is formed of at least two-layer layer or four-layer coating like TiO₂/SiO₂, SiO₂/TiO₂/SiO₂ and TiO₂/SiO₂/TiO₂/SiO₂, which has a complicated process and cannot well be applied to a large area. The TiO₂ is a very thin thickness of 15 nm˜30 nm, so it is very sensitive to moisture while producing a lot of error rates.

Therefore, both the fine pattern etching method and the multiple-layer coating method have complicated processes, and it is not easy to control the qualities, which results in an increase in manufacturing cost. So, a single layer coating method has been researched, which has a simple process and economic advantages.

The following conditions are obtained from Fresnel formula.

$$\begin{matrix}{n}_{1} = \sqrt{{n}_{t}} & [ 8 ] \\ k = 2 π / λ & [ 9 ] \\ l = \frac{1}{4} λ & [ 10 ]\end{matrix}$$

In case that the reflectivity of a substrate like glass is nₜ=1.52, when the AR coating is n₁=1.23, and has a thickness of ¼ of wavelength, since it is impossible to find a substance having a low reflectivity although the reflectivity has a value close to 0% in visible light, it is needed to make a pore by using the following formula resulting from a relationship between density and reflectivity in order to convert the substance with a reflectivity of 1.52 to a substance having a reflectivity of 1.23.

$${n}_{p}^{2} = ( {n}^{2} - 1 ) ( 1 - \frac{100}{p} ) + 1 \qquad [ 12 ]$$

When a substance with reflectivity of 1.52 (n value) has 60% of a porosity (p value), the reflectivity becomes close to 1.23 (nₚ value). Here when the size of a pore is similar with the wavelength of light, the coating layer becomes opaque due to the scattering of light, so the size of a pore should be to below a few hundreds of nano meters which are much lower than the wavelength of light.

In the porous single layer coating method, a polymer binder mixture is coated on a substrate, and a polymer component is eliminated by extraction or calcinations for thereby forming pores. In another method, a two-polymer is mixture is coated on a substrate, and a polymer of one component is extracted by solvent for thereby forming a pore. The above method needs a high temperature plasticity process or a process for extracting solvent is complicated. Since a toxic solvent is needed, an environment problem might occur.

### DISCLOSURE OF INVENTION

Accordingly, it is an object of the present invention to provide a coating formulation affording an antireflection effect with respect to a transparent substrate at a lower cost by providing a single coating layer.

It is another object of the present invention to provide a method for manufacturing a transparent substrate having an antireflection function which can be easily applied to a transparent substrate with a large area and which can be actually applicable for the purpose of economy.

To achieve the above objects, there is provided a coating formulation affording antireflection effects on a transparent substrate, comprising water; metalloid oxide nano particles that are dispersed in said to water; and a hydroxide ion agent or fluoride ion agent that is introduced into said metalloid oxide nano particles at a mole ratio of 0.005˜2:1.

In addition, there is provided a method for manufacturing a transparent substrate with an antireflection function using the coating formulation, comprising a step for washing a surface of a transparent substrate; is a step for coating on a surface of the washed transparent substrate a formulation formed of water; metalloid oxide nano particles that are dispersed in said water; and a hydroxide ion agent or fluoride ion agent that is introduced into said metalloid oxide nano particles at a mole ratio of 0.005˜2:1; and a step for drying the coated surface. If necessary, the washing and dry might be repeatedly performed after dry.

The metalloid oxide nano particle is preferably selected from the group consisting of silica, alumina, titania, magnesia, seria, zinc oxide, indium oxide, tin oxide and a mixture of the same, and the transparent substrate might include a transparent plastic and is generally a metalloid oxide or a transparent substrate coated with the metalloid oxide and is preferably selected from the group consisting of silica, alumina, titania, magnesia, seria, zinc oxide, indium oxide, tin oxide and a mixture of the same, glass or a substrate coated with the metalloid oxide or glass, and is most preferably glass.

The coating formulation is applied to a glass substrate within 30 days after a hydroxide ion agent or fluoride ion agent is introduced depending on situation or is applied to a glass substrate within 24 hours depending on situation. When the concentration of hydroxide ion agent or fluoride ion agent is relatively higher, the gelation or the dissolution of the nano silica particles might occur within 24 hours depending on pH, so the application cannot be performed.

The coating formulation might further include an organic solvent and/or an interface activator having a low surface tension such as methanol or ethanol, if necessary. The organic solvent is 10 weight %˜90 weight % of the total coating formulation, and preferably, is 20˜40 weight %.

The metalloid oxide nano particle is preferably 1˜10 weight % of the total weights of the coating formulation, and the particle size of the metalloid oxide nano particle is 1˜800 nm, preferably, 5˜100 nm. The metalloid oxide nano particle having a size less than 5 nm is difficult to manufacture, and the metalloid oxide nano particle having a size more than 100 nm might have a decrease in the transmittance due to the scattering.

The hydroxide ion agent is inorganic hydroxide or organic hydroxide and may be formed of various types of hydroxides and is preferably NH₄OH. At this time, in case of the silica nano particle, the mole ratio of [OH⁻]/[SiO₂] is 0.05 to 2.0 in order to obtain a stability of the solution and a proper adhesive force between particles, and is most preferably 0.1 to 0.5.

The fluoride ion agent is preferably HF, H₂SiF₆ or its salt and is most preferably KF or NH₄F. At this time, in case of the silica nano particle, the mole ratio of [F⁻, HF⁻₂]/[SiO₂] is preferably 0.005 to 1.0 in order to obtain a proper adhesive force between particles and is most preferably 0.01 to 0.5. The pH of the solution is preferably maintained at above 8.5.

The coating formulation is coated on a substrate by a spray coating method, a spin coating method, a dip coating method, a slot die coating method, etc. The coating formulation can be coated in multiple layers if necessary. The porosity of a nano particle can be made larger in the layer which is remoter from is the substrate. A high transmittance can be maintained for a long time along with the increase of the surface hardness of an antireflection later in such a manner that perfluoro alkyl (alkoxy) silane substituted with a functional group of alcohol, silane, acetate acid, amine and halogen or perfluoropolyether or a derivate of the same is coated on the antireflection substrate.

The mechanism of a bonding of nano particles or a nano particle and a substrate will be described using a silica nano particle and a glass substrate. The mechanism is described just as an assumption, and the present invention is not limited thereto. It is assumed that the hydroxide ion agent used in the present invention is partially resolved with the nano silica particle and the surface of a substrate glass based on the following reaction.

SiO₂+OH⁻+2H₂O→Si(OH)⁻₅ 1)

When the coating formulation containing hydroxide ion agent of the present invention is coated on the glass substrate and dried, the following reaction can be assumed. A solid bonding is made between silica nano particles or a silica nano particle and a glass substrate.

Nano particle-Si—OH+HO—Si-nano particle→Nano particle-Si—O—Si-nano particle+H₂O 2)

Nano particle-Si—OH+HO—Si-glass surface→Nano particle-Si—O—Si-glass surface+H₂O

It is assumed that the fluoride ion agent used in the present invention is partially resolved with a nano silica particle and the surface of a is substrate glass based on the following reaction.

SiO₂+6F−+6H⁺→H₂SiF₆+2H₂O 4)

When the coating formulation containing a fluorine ion agent according to the present invention is coated on a glass substrate and is dried, it can be assumed that the following reaction occurs. A solid bonding is made between silica nano particles or a silica nano particle and the surface of a glass substrate.

Nano particle-Si—F+HO—Si-nano particle→Nano particle-Si—O—Si-nano particle+HF 5)

Nano particle-Si—F+HO—Si-glass surface→Nano particle-Si—O—Si-glass surface+HF 6)

### Effects

The coating formulation according to the present invention helps manufacture a nano porous antireflection film having a high transmittance by a more simplified process as compared to the conventional art. An adhesive force between a film and a substrate can be enhanced by increasing a bonding to between particles and an adhesive force between a particle and a substrate, which results in manufacturing an antireflection film having a reliable durability.

### BRIEF DESCRIPTION OF THE DRAWINGS

The present invention will become better understood with reference to is the accompanying drawings which are given only by way of illustration and thus are not limitative of the present invention, wherein;

FIG. 1 is a graph illustrating a transmittance of a substrate (comparison example 2) when an antireflection film according to an embodiment 20 of the present invention is formed and an antireflection film is not formed;

FIG. 2 is a graph illustrating a transmittance of a substrate (comparison example 3) when an antireflection film according to an embodiment 21 of the present invention is formed on an ITO glass substrate and an antireflection film is not formed;

### MODES FOR CARRYING OUT THE INVENTION

### Embodiment 1

55 mL of distilled water was added to 45 mL of colloidal silica (Ace Hitech, Silifog) 10 weight % of which an average particle size was 6 nm, and mixture was treated for about 30 minutes by sonication for thereby manufacturing a silica dispersed solution of 4.5 weight % concentration. 0.14 g of NH₄F was added to the dispersed solution, and a mole ratio of [NR₄F]/[SiO₂] to was set to 0.05, and the mixture was treated for about 30 minutes by sonication for thereby preparing a coating formulation. The coating formulation was treated in such a manner that part of the same was made in order to observe a gelation, pH and a size of silica particle, and the pH and the size of silica particle of the solution were measured by using a pH meter (Hanna HI221) and the particle is analyzer made by Malvern every 15 days.

The soda lime glass was well washed by using washing agent and was dipped in 1M of KOH solution for 5 hours and was washed by distilled water and was dried by blowing air, not leaving any water marks. The prepared coating formulation was coated on the soda lime glass 12 hours after manufacture by means of the spin coating method and was coated at a speed of 800 rpm at 20° C. and 20% of relative humidity for thereby forming a silica coating film, and the silica coating film was dried for 3 hours at 120° C.

The transmittance and reflectance of the manufactured sample was measured by using the UV-3100PC spectrum photometer made by Shimadzu company. The hardness of the antireflection film was measured by a pencil hardness tester based on the standard method of ASTM D3360-00, and the adhesive force of the antireflection film was obtained by performing the Scotch tape test based on the standard method of ASTM D3359. The measured physical properties are shown in Table 1.

### Comparison Example 1

The comparison was performed in the same manner as the embodiment 1 except that the silicon solution not added with NH₄F was directly used as a coating formulation. The measured physical properties are shown in Table 1.

### Embodiments 2˜4

In the embodiments 2˜4, the embodiments were implemented in the same manner as the embodiment 1 except that NH₄F was used by 0.27 g, 0.55 g and 1.11 g, respectively, provided that when the gelation and the size of the nano silica particle of the coating formulation decreased within 12 hours after the manufacture, the coating was not performed. The measured physical is properties are shown in Table 1.

### Embodiments 5˜8

The embodiments were implemented in the same manner as the embodiment 1 except that H₂SiF₆ was added instead of NH₄F by 0.08 g (equivalent to 0.007 mole ratio), 0.18 g, 0.35 g, and 0.72 g (equivalent to 0.066 mole ratio), respectively, provided that when the gelation and the size of the nano silica particle of the coating formulation decreased within 12 hours after the manufacture, the coating was not performed. The measured physical properties are shown in Table 1.

### Embodiments 9˜12

The embodiments were implemented in the same manner as the embodiment 1 except that KOH was used instead of NH₄F by 0.21 g, 0.42 g, 0.84 g and 1.68 g, respectively, provided that when the gelation and the size of the nano silica particle of the coating formulation decreased within 12 hours after the manufacture, the coating was not performed. The measured physical properties are shown in Table 1.

### Embodiments 13˜14

The embodiments were implemented in such a manner that the perflourpolyether solution made by Solvay company was added to Galden ZV-130 solvent and was diluted to 0.3 weight % in the thin film sample manufactured in the embodiments 3 and 4 and was coated by the spin coating method to have a thickness of about 2-5 nm and was dried for one hour at 120° C. The surface hardness of the film was measured by using a pencil hardness tester based on the standard method of ASTM D3360-00, and the hardness values are shown in Table 2, which shows that the H value was increased by one step without the loss in the transmittance.

### Embodiment 15

55 mL of distilled water was added to 45 mL of colloidal silica (Ace Hitech, Silifog) 10 weight % of which an average particle size was 6 nm, and mixture was treated for about 30 minutes by an ultrasonic homogenizer for thereby manufacturing a silica dispersed solution of 4.5 weight % concentration. 0.3 g of NH₄F was added to the dispersed solution, and the mixture was treated for about 30 minutes by sonication for thereby preparing a coating formulation.

The soda lime glass was well washed by using washing agent and was dipped in 1M of KOH solution for 4˜6 hours and was washed by distilled water and was dried by blowing air, not leaving any water marks. The prepared coating formulation was coated on the soda lime glass by the spin coating method at a speed of 800 rpm at 20° C. and 20% of relative humidity for thereby forming a silica coating film, and the silica coating film was dried for 3 hours at 120° C.

The transmittance and reflectance of the manufactured sample was measured by using the UV-3100PC spectrum photometer made by Shimadzu company. The hardness of the antireflection film was measured by a pencil hardness tester based on the standard method of ASTM D3360-00, and the adhesive force of the antireflection film was obtained by performing the Scotch tape test based on the standard method of ASTM D3359. The measured physical properties are shown in Table 3.

### Embodiments 16˜19

The embodiments were implemented in the same manner as the embodiment 15 except that 15, 20, 40 nm (Ace Hitech, Silifog) of the average size of the silica particles and 120 nm (Evonik, Aerodisp) instead of 6 nm of the average size of the silica particles were used. The characteristics of the antireflection film were shown in Table 3.

### Comparison Example 2

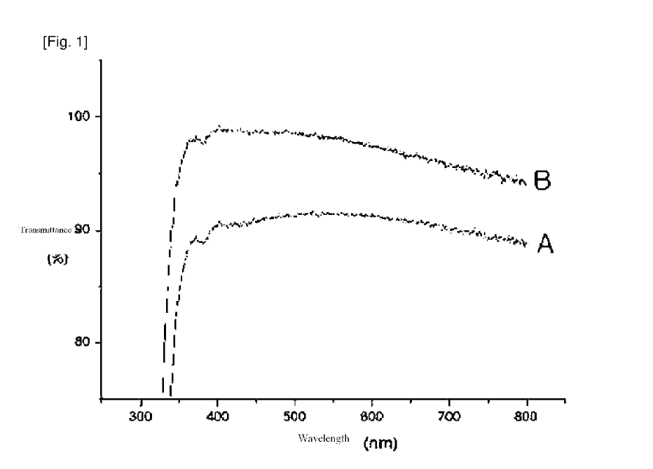

The soda lime glass was well washed by using washing agent and was dipped in 1M of KOH solution for 5 hours and was washed by distilled water and was dried by blowing air, not leaving any water marks. The antireflection film process was not performed, and the remaining procedures were performed in the same manner as the embodiment 1, and the transmittance was shown by the curve A of FIG. 1 formed about the visible light region.

### Embodiment 20

The embodiment was performed in the same manner as the embodiment 1 except that the back surface of the soda lime glass has a coating film with respect to the soda lime glass after the silica coating film was manufactured by the embodiment 1 for thereby forming the antireflection film at both surfaces. The transmittance is shown by the curve B in FIG. 1 about the visible light region. In this case, about 10% of transmittance in maximum was obtained as compared to the comparison example 2 in which the antireflection film was not formed.

### Comparison Example 3

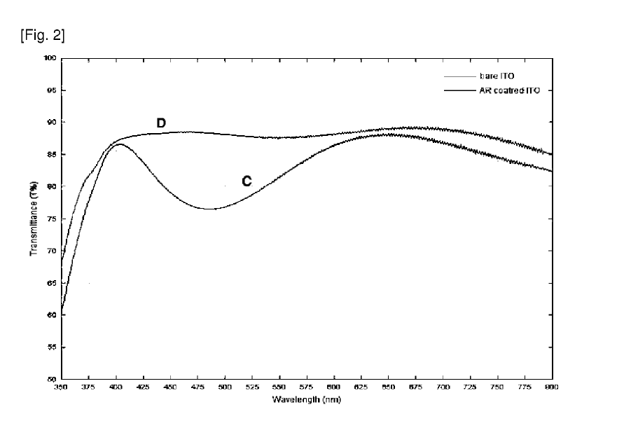

The glass sample piece coated with ITO was washed by ethanol and secondary distilled water in ultrasonic wave method for 20 minutes, respectively, and was treated by oxygen plasma (at this time, it was performed for 3 minutes with the partial pressure of oxygen being 0.2 Torr and RF output being 100 W) for thereby eliminating the pollutants from the surfaces. The glass sample piece coated with the oxygen plasma-treated ITO was used instead of soda lime glass, and the example was performed in the same manner as the embodiment 1 is except for the treatment of the antireflection film. The transmittance is shown by the curve C in FIG. 2 about the visible light region.

### Embodiment 21

The embodiment was performed in the same manner as the embodiment 1 except that the glass sample piece coated with ITO instead of soda lime glass was washed by ethanol and secondary distilled water in ultrasonic wave method for 20 minutes, respectively, and was treated by oxygen plasma (the wetness of ITO surface increases, and at this time, it was performed for 3 minutes with the partial pressure of oxygen being 0.2 Torr and RF output being 100 W) for thereby eliminating the pollutants from the surfaces. The pencil hardness of the antireflection film was 3H, and the transmittance of the sample coated with the silica antireflection film on one surface in the side of the ITO has increased by about 5% as compared to the ITO glass substrate which was not coated with antireflection film. The transmittance is shown by the curve D in FIG. 2 about the visible light region. No change in the resistance of the ITO thin film was observed.

TABLE 1

| | composition | | Physical properties | | |
|---|---|---|---|---|---|
| | | Concentration | Stability of | | Pencil |
| Number | Catalyst | (wt %) | solution | Transmittance | hardness |
| Comparison | Not added | — | No changes | 94% | HB |
| example 1 | | | for 15 days | | |
| Embodiment 1 | NH₄F | 0.14 | No changes | 94.2% | 2H |
| | | | for 15 days | | |
| Embodiment 2 | | 0.27 | No changes | 94.4% | 3H |
| | | | for 15 days | | |
| Embodiment 3 | | 0.55 | Gelation | 92.5% | 4H |
| | | | within 24 | | |
| | | | hours | | |
| Embodiment 4 | | 1.11 | Gelation | — | — |
| | | | within 3 | | |
| | | | hours | | |
| Embodiment 5 | H₂SiF₆ | 0.08 | No changes | 93.5% | 2H |
| | | | for 15 days | | |
| Embodiment 6 | | 0.18 | No changes | 94% | 2H |
| | | | for 15 days | | |
| Embodiment 7 | | 0.35 | Gelation | — | — |
| | | | within 8 | | |
| | | | hours | | |
| Embodiment 8 | | 0.72 | Gelation | — | — |
| | | | within 3 | | |
| | | | hours | | |
| Embodiment 9 | KOH | 0.21 | No changes | 93% | 2H |
| | | | for 15 days | | |
| Embodiment | | 0.42 | No changes | 93% | 2H |
| 10 | | | for 15 days | | |
| Embodiment | | 0.84 | No changes | — | — |
| 11 | | | for 15 days | | |
| Embodiment | | 1.68 | Silica | — | — |
| 12 | | | dissolved | | |

TABLE 2
Additional coating of perfluoropolyether

| Number | transmittance | Pencil hardness |
|---|---|---|
| Embodiment 13 | 94.3% | 4H |
| Embodiment 14 | 92.6% | 5H |

TABLE 3
Characteristics of antireflection film based on particle size

| | | | Transmittance |
|---|---|---|---|
| Number | Size (nm) | hardness | (%) |
| Embodiment 15 | 6 | 3H | 94.5 |
| Embodiment 16 | 15 | 3H | 94.2 |
| Embodiment 17 | 20 | 2H | 94.1 |
| Embodiment 18 | 40 | 2H | 93.0 |
| Embodiment 19 | 120 | HB | 92.2 |

### INDUSTRIAL APPLICABILITY

The AR technology adapting the present invention can be widely applied to an optical instrument such as a telescope, glasses, optical communication parts, a photoelectric device, a solar device and a display part.

1. A coating formulation affording antireflection effects on a transparent substrate, comprising:
water;
metalloid oxide nano particles that are dispersed in said water; and
a hydroxide ion agent or fluoride ion agent that is introduced into said metalloid oxide nano particles at a mole ratio of 0.005˜2:1.

2. A coating formulation affording antireflection effects on a transparent to substrate of claim 1, wherein said metalloid oxide nano particle is selected from the group consisting of silica, alumina, titania, magnesia, seria, zinc oxide, indium oxide, tin oxide and a mixture of the same, and said transparent substrate is metalloid oxide selected from the group consisting of silica, alumina, titania, magnesia, seria, zinc oxide, indium oxide, tin oxide and a mixture of the same, glass or a substrate coated with the same.

3. A coating formulation affording antireflection effects on a transparent substrate of claim 2, wherein said metalloid oxide nano particle is a silica nano particle, and said transparent substrate is glass.

4. A coating formulation affording antireflection effects on a transparent substrate of claim 1, wherein said coating formulation further contains methanol or ethanol as a surface tension inhibitor by 10 weight %˜90 weight % of the entire coating formulations.

5. A coating formulation affording antireflection effects on a transparent substrate of claim 1, wherein said coating formulation is applied to a glass substrate within 30 days after a hydroxide ion agent or fluoride ion agent is introduced.

6. A coating formulation affording antireflection effects on a transparent substrate of claim 1, wherein the nano silica in said coating formulation is 1˜10 weight % with respect to the total weights of the coating formulation, and said nano silica has a particle size of 5˜100 nm.

7. A coating formulation affording antireflection effects on a transparent is substrate of claim 5, wherein a hydroxide ion agent in said coating formulation is NH₄OH, and a mole ratio of [OH⁻]/[SiO₂] is 0.05 to 2

8. A coating formulation affording antireflection effects on a transparent substrate of claim 5, wherein a fluoride ion agent is HF, H₂SiF₆ or its salt, and a mole ratio of [F⁻, HF⁻₂]/[SiO₂] is 0.005 to 1.0.

9. A method for manufacturing a transparent substrate with an antireflection function using the coating formulation, comprising:
a step for washing a surface of a transparent substrate;
a step for coating on a surface of the washed transparent substrate a formulation formed of water; metalloid oxide nano particles that are dispersed in said water; and a hydroxide ion agent or fluoride ion agent that is introduced into said metalloid oxide nano particles at a mole ratio of 0.005˜2:1; and
a step for drying the coated surface.

10. A method for manufacturing a transparent substrate with an antireflection function using the coating formulation of claim 9, wherein said metalloid oxide nano particle is selected from the group consisting of silica, alumina, titania, magnesia, seria, zinc oxide, indium oxide, tin oxide and a mixture of the same, and said transparent substrate is metalloid oxide selected from the group consisting of silica, alumina, titania, magnesia, seria, zinc oxide, is indium oxide, tin oxide and a mixture of the same, glass or a substrate coated with the same.

11. A method for manufacturing a transparent substrate with an antireflection function using the coating formulation of claim 9, wherein said metalloid oxide nano particle is a silica nano particle, and said transparent substrate is glass.

12. A method for manufacturing a transparent substrate with an antireflection function using the coating formulation of claim 9, further comprising a step for coating perfluoro alkyl (alkoxy) silane, perfluoropolyether or a derivate of the same.

13. A method for manufacturing a transparent substrate with an antireflection function using the coating formulation of claim 10, wherein said coating formulation is applied to a glass substrate within 30 days after a hydroxide ion agent or fluoride ion agent is introduced.

14. A method for manufacturing a transparent substrate with an antireflection function using the coating formulation of claim 11, wherein the nano silica in said coating formulation is 1˜10 weight % with respect to the total weights of the coating formulation, and said nano silica has a particle size of 5˜100 nm, and hydroxide ion agent is NH₄OH, and a mole ratio of [OH⁻]/[SiO₂] is 0.5 to 1.2.

15. A method for manufacturing a transparent substrate with an antireflection function using the coating formulation of claim 12, wherein the nano silica in said coating formulation is 1˜10 weight % with respect to the total weights of the coating formulation, and said nano silica has a particle size of 5˜100 nm, and fluoride ion agent is HF, H₂SiF₆ or its salt, and a mole ratio of [F⁻, HF⁻₂]/[SiO₂] is 0.005 to 1.0.
